(19) United States
(12) Patent Application Publication
(10) Pub. No.: US 2010/0023955 A1
(43) Pub. Date: Jan. 28, 2010

(54) METHOD AND SYSTEM AND APPARATUS FOR DYNAMIC SOFTWARE ENVIRONMENT

(75) Inventor: Luc Verbist, Palo Alto, CA (US)

Correspondence Address: PERKINS COIE LLP, P.O. BOX 1208, SEATTLE, WA, 98111-1208, US

(73) Assignee: Marcottage, Palo Alto, CA (US)

(21) Appl. No.: 12/509,702

(22) Filed: Jul. 27, 2009

Related U.S. Application Data
(60) Provisional application No. 61/084,236, filed on Jul. 28, 2008.

(51) Int. Cl. G06F 9/46; G06F 15/16

(52) U.S. Cl. 719/332; 709/219

(57) ABSTRACT

A method and system are provided for runtime dynamic binding. The system includes a processor for executing computer-readable instructions. The system includes a computer-readable medium for storing an object definition in communications with the processor. The system includes a user object instantiated from the object definition, the object definition including a programmer-defined lookup method and a programmer-defined binding method. The programmer-defined lookup method dynamically searches and retrieves a requested functionality. The programmer-defined binding method dynamically binds the requested functionality at runtime for execution without a system restart.

### CROSS REFERENCE TO RELATED APPLICATIONS

This application claims priority to provisional application No. 61/084,236 entitled “METHOD, SYSTEM AND APPARATUS FOR REFLECTIVE, RETARGETABLE AND DYNAMIC ADAPTABLE SOFTWARE ENVIRONMENT”, filed Jul. 28, 2008, and which is incorporated herein by reference.

### BACKGROUND

Changes (such as configurations, update, etc.) to software are usually achieved by an external event, for a non-limiting example, when a person requests it or a service application issues a request at a predefined time. Currently, such change or update is coarse-grain and happens at the library level, and often requires re-installing parts of code up to date. All functionalities have to be available at the time of the update and all are installed. Consequently, resource usages and full functionalities of the computing device running the software are locked in at the time an update is made and the user of this release of the software is obligated to have it completely and permanently installed. Most of the time, a complete software upgrade is destructive, e.g., reverting back to a previous version is not even always possible, implying that multiple interactive steps such as uninstall, re-install, and upgrade are required until the version of the user's interest is obtained.

Prior approaches include programming an application, distributing it via various means (retail, online, application store front, etc.) and providing maintenance as an additional service. The maintenance or upgrade is disruptive and its environment needs to be identical to a specific release/update when it was programmed for. Keeping an application automatically up to date by providing a fine grain continuous access to new or revised functionality one can create many more permutations than a pre-compiled legacy application.

### BRIEF DESCRIPTION OF THE DRAWINGS

These and other objects, features and characteristics of the present invention will become more apparent to those skilled in the art from a study of the following detailed description in conjunction with the drawings, which form a part of this specification. In the drawings:

FIG. 1 depicts a graphical representation of an example of a system to support a dynamic software environment.

FIG. 2 depicts an example of a functional representation of a dynamic software environment that enables a developer to interact and have access to the whole system.

FIG. 3 depicts an example of a default object provided by the object model of a dynamic software environment.

FIG. 4 depicts an example of behaviors shared across multiple instances of an object.

FIG. 5 depicts an example of delegation where multiple objects are daisy-chained to show multiple derivatives.

FIG. 6 depicts an example of proxy object that enables a ‘link’ between local requirements and remote code availability.

FIG. 7 depicts an example of proxy object delegation for remote access to unimplemented messages.

FIG. 8 depicts an example of the management of multiple versions of a user object.

### DETAILED DESCRIPTION OF EMBODIMENTS

A new approach is introduced to construct software systems, which are composed of programming languages and applications, in a dynamically adaptable environment with supporting hardware resources and a dynamic code generator. The environment enables software program adjustments and configurations without external events and allows software programs (components) to be swapped back in or portions of code to be removed dynamically at run time without a system restart. It keeps the software programs up to date with exchangeable configurations and revisions available remotely without human intervention or massive replacement of full sets of code or rebooting of the system. It also provides the foundation for distributed application development and deployment.

Similarly, the approach is extended to data. In one embodiment, data is stored in a cloud network, and retrieved on demand after remote execution of computer instructions.

In contrast to prior approaches, an Application System and Service provide subscribers access to desired applications and data. The subscriber does not have to keep track of version installed, interoperability, etc. while being always running with the most recent functionality. A similar methodology can be used for developing and distributing common components or libraries.

Furthermore, the Application System and Service provides continuous access to fine grain functionality, additional features become available. First, multiple version of functionality or data can be available simultaneously and accessible as appropriate. Second, the application can ‘swap out’ and be removed from memory. When necessary to use, the local computing device can retrieve it back from the cloud network for execution. Third, the fine grain code usage and potential trade off for remote execution can be monitored and allows the application optimizes itself automatically for its environment (device and usage), and able to give feedback to the developers of the application

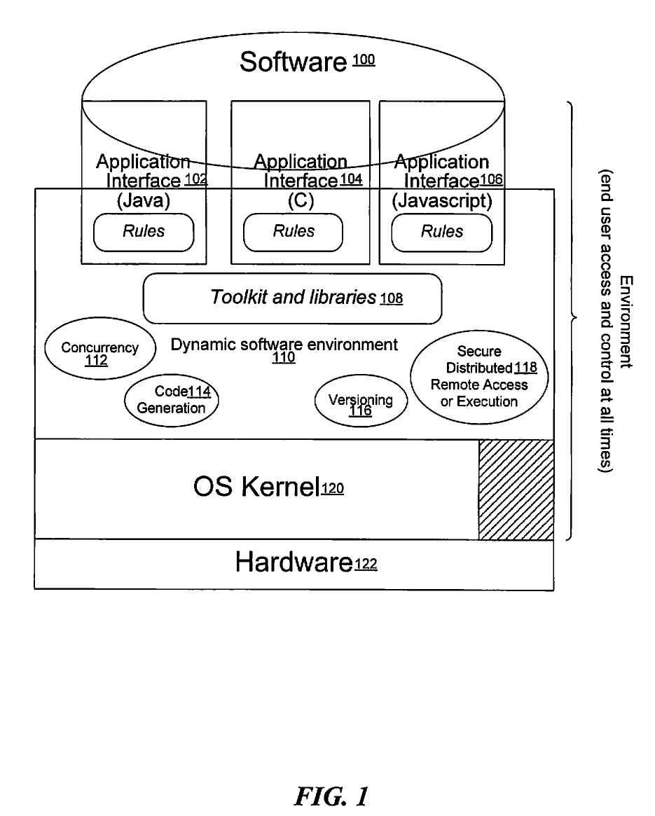

FIG. 1 depicts a graphical representation of an example of a system to support a dynamic software environment. The environment can be platform independent, allowing source code to execute across a plurality of platforms. The environment can propagate updates within the cloud network, thus always providing the latest version of source code and data. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

The connection is secure and one can implement their own methodology to grant access such ACL (access control lists), capabilities, sandboxing, etc. Capabilities is a natural fit for the dynamic software environment, along with passing on the message one send its key as well, the receiving object verifies if it ‘allows’ or is capable to process the request or will return with an non authorized message. However the object model does not restrict you to a specific security type model.

When a change is made, the server informs its clients and upon this the clients apply these changes, as of it reflects on its environment where it communicates/interacts with. Or the clients checks before execution if changes are available

In the example of FIG. 1, the dynamic software environment embodies an object model and implements services such as versioning, concurrency, resource control and language interfaces. The dynamic software environment can be deployed on top of an OS or bare-bone hardware and is at all times under end user control. For non-limiting examples, the end user can now create compilers, traditional virtual machines or toolkit libraries to import various lexical grammars based on the dynamic software environment. Versioning, keeping the system update in a fine-grain matter, and late binding are directly inherited by the object model described below. Secure remote access, executions and concurrency are basic functionalities provided by the dynamic software environment.

Software 100, for example, computer-readable instructions or source code, can be converted via application interfaces 102, 103, and 106. The application interfaces can each include rules for converting the software for execution on the dynamic software environment 110.

The dynamic software environment 110 can include toolkit and libraries 108 for executing software, along with various modules. Modules can include concurrency 112, code generation 114, versioning 116, and secured distributed remote access or execution 118. Each module can provide a specified function.

The dynamic software environment 110 can execute on an OS kernel 120, which interfaces with hardware 122. The hardware 122 can be a local computing device, such as a personal computer, workstation, cellular phone, mobile device, etc.

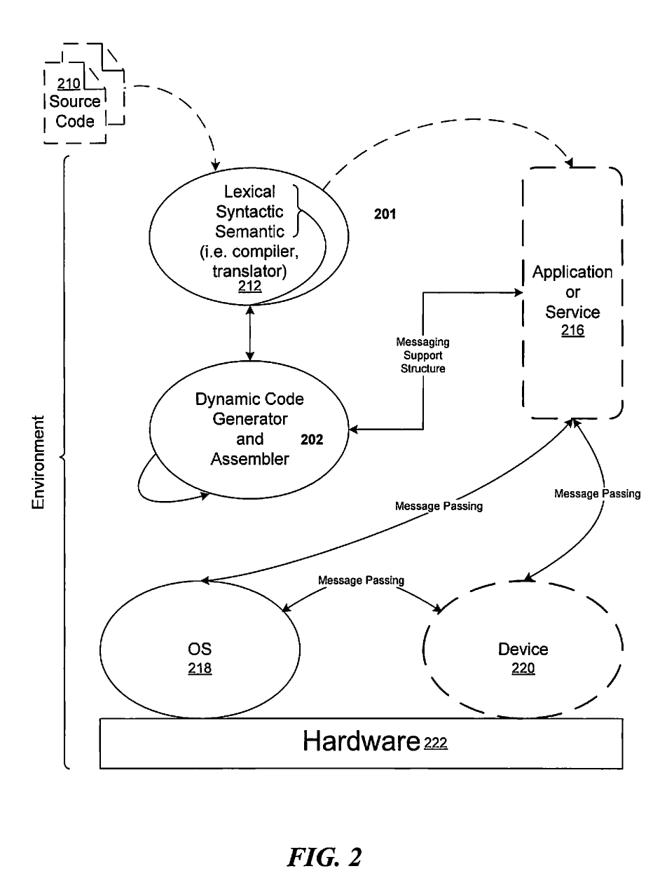

FIG. 2 is an example of a functional representation of the dynamic software environment that enables a programmer (end user) to interact with an entire system and to make code and behavioral changes to every part of the system at runtime. Applications, services, drivers, etc. can be written in a language appropriate for their functions and can be changed and customized according to the execution environment. Source code 210 is translated into a structured representation or abstract syntax tree (AST) by a compiler or translator 212. The AST is executed in 201 which provides an application or service 216.

For example, the source code 210 can be received as code written in a programming language to be converted into byte code, or as byte code ready for use.

By applying transformations repeatedly, a minimum set of virtual instructions can be created, which can be consumed by a code generator and a dynamic assembler 202, for providing executable code. The system's foundation is the object model and can be written in itself (e.g., self hosted), hereby all characteristics of this model become these of the dynamic software environment, its libraries, and applications as well (versioning, late binding or reflective).

The core underlying component of dynamic software environment is the object model. The object model does not enforce any structure on end user objects. Rather, the object model has its own messaging passing semantics, making the implementation replaceable from within the compiler or translator and application. In addition, the object model can easily support various language features such as inheritance and mixed mode execution. Providing very late binding (at runtime) and exposing warning message (e.g., ‘doesNotUnderstand’) allows an end user to implement various behaviors such as remote upgrades, swapping in/out code (i.e. code control) and remote execution.

In one embodiment, the system can retrieve source code or byte code representing computer instructions for providing a requested functionality. The source code or byte code is processed and executed locally at runtime. Alternatively, any representation of computer instructions can be retrieved.

In another embodiment, the requested functionality can be provided remotely via a cloud network. For example, a local computing device can request a computation to be performed and the arguments are transmitted for the computation. The computation is then performed by the cloud network, for example, at a remote server or another computing device, and computation results are transmitted back to the local computing device.

In another embodiment, the system can retrieve data in addition or in place of source code. This allows data to be propagated throughout a cloud computing system and ensure only the latest version of data is used by the local computing device.

In another embodiment, a functionality and data usage history can be analyzed to determine what functionality is used most often by a local computing device. For example, the analysis can be done by the local computing device or remotely in a cloud network. The analysis can be used to determine what source code and data are retained by the local computing device for fast access. For example, source code and data that are not frequently accessed can be retained by the cloud network, freeing up memory and other resources at the local computing device.

The above execute on an operating system (218) 218 and hardware 222. It will be appreciated that the OS 218 can pass messages to an optional device 220.

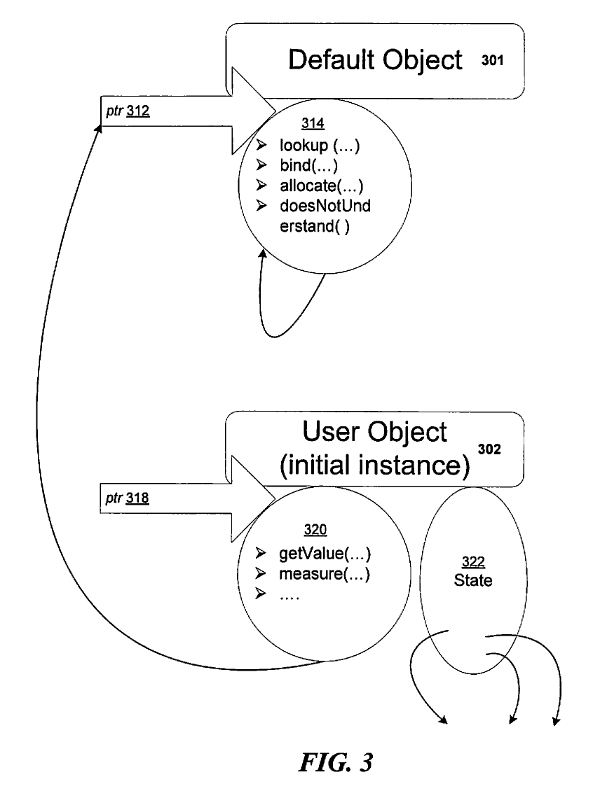

FIG. 3 depicts an example of a default object provided by the object model of dynamic software environment. In the example of FIG. 3, object 301 with a default implementation of methods 314 can lookup a message, binding a message and argument for execution and allocation of the object. The default object 301 does not hold any state. Rather, it only provides functionality (by providing messages) to allocate, lookup and bind an object message (i.e. execution code) to a literal name. In addition, it holds a reference 312 to a parent which points to itself.

For example, the lookup ( ) method can include instructions to search and retrieve code for execution. The bind ( ) method can bind arguments to retrieved code and execute.

User object 302 implements its own behavior by holding messages 320 that implements its functionality (for example, getValue ( ) and measure ( )) and a reference 318 back to the default object 301 for the initial implementation of the messages imposed by the model. The state 322 of the user object 302 is an association of literal names and other user objects (primitives such integer, floats, etc. are objects as well).

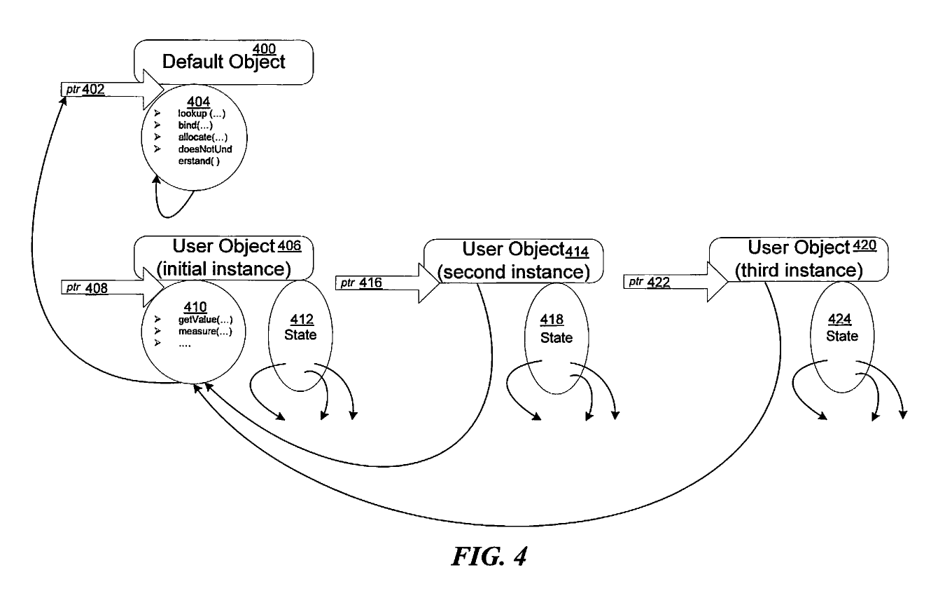

FIG. 4 depicts an example of behaviors shared across multiple instances of an object sharing the same implementation but each has a unique state. A default object 400 includes a pointer 402 and defined methods 404. User objects 406, 414, and 420 are instantiated from the default object 400. Each user object includes a pointer (408, 416, and 422) and a state (412, 418, and 424).

At runtime, when a getValue ( ) is send to the user object, a lookup ( ) with the message name as argument is performed. The lookup ( ) will find the execution code associated with this message (a bind operation was performed during the implementation phase associating the message with executable code). Once found, it will execute the associated code with the proper arguments. If not found, the object model will issue a lookup of the doesNotUnderstand ( ) and executes its associated code. We have default implementations for lookup ( ) and doesNotUnderstand ( ) in the default object. doesNotUnderstand ( ) errors out, lookup will first look for an association in the current object, if not found, it will follow the parent reference and proceed the lookup at that level. At runtime (i.e. late binding) we can bind execution code with a message through the bind ( ) message defined in the default object, we also can overload the lookup ( ) and doesNotUnderstand ( ) at any level and any time. With another words, the user has full control over the behavior at compile and runtime, nothing is implied by the compiler or system.

It will be appreciated that user objects 414 and 420 do not need to define methods as they can simply reference methods 410 defined by user object 406.

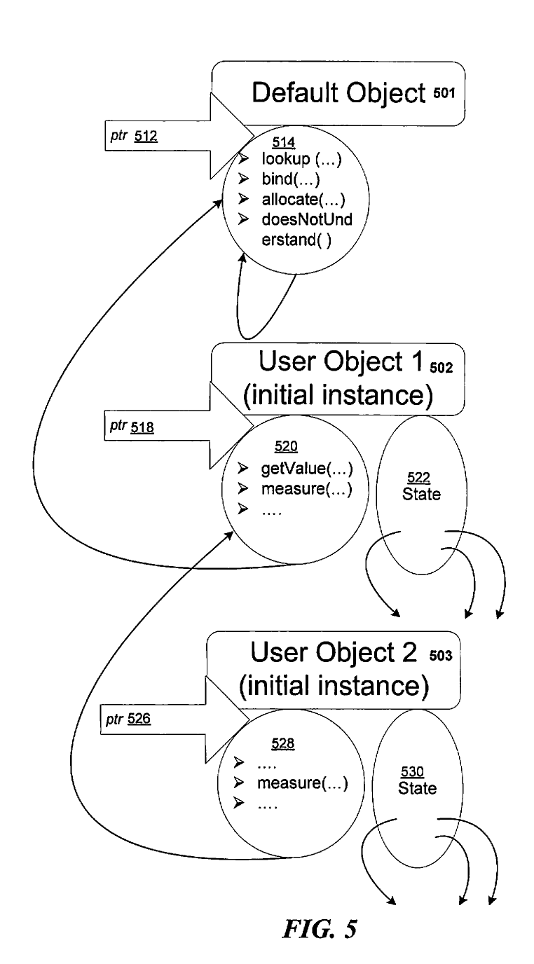

FIG. 5 depicts an example of delegation where multiple objects are daisy-chained to show multiple derivatives. In the example of FIG. 5, user object 2 503 is derived from user object 1 502. Since the end user always tries to find the ‘lookup’ message first, how the invoked message will be found in the objects can be explored by traversing upwards by default all the way to the default object 501. When found, the arguments are bound with the message, which gets executed. Notice that at any time, the end user can overload the ‘lookup’ message, ‘doesNotUnderstand’ etc., i.e. the object model semantics are under control of the end user.

The default object 501 includes a pointer to itself 512 and defined methods 514. The user object 1 502 includes a pointer 518, defined methods 520, and a state 522. The user object 2 503 includes a pointer 526, defined methods 528, and a state 530.

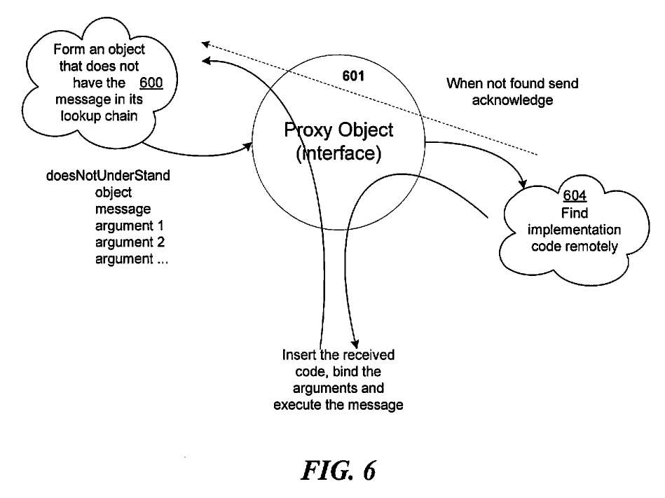

FIG. 6 depicts an example of proxy object that enables a ‘link’ between local requirements and remote code availability. The proxy object 601 is an object that interfaces with a remote resource and able to query that resource for execution code. It enables an end user to build an infrastructure where a program does not have to be complete for execution nor fully reside at the host. This remote resource at its turns can again query other resources. For a non-limiting example, if a program that tries to execute measure ( ) on object ‘obj’ and the message is not available (nor implemented), doesNotUnderstand ( ) errors out by default.

In 600, a message is not found in an object's look up chain. The object can interact with the proxy object 601 which attempts to find the desired functionality (implementation code) remotely at 604. For example, the functionality can be retrieved from a remote server, a cloud network, or some other accessible storage medium.

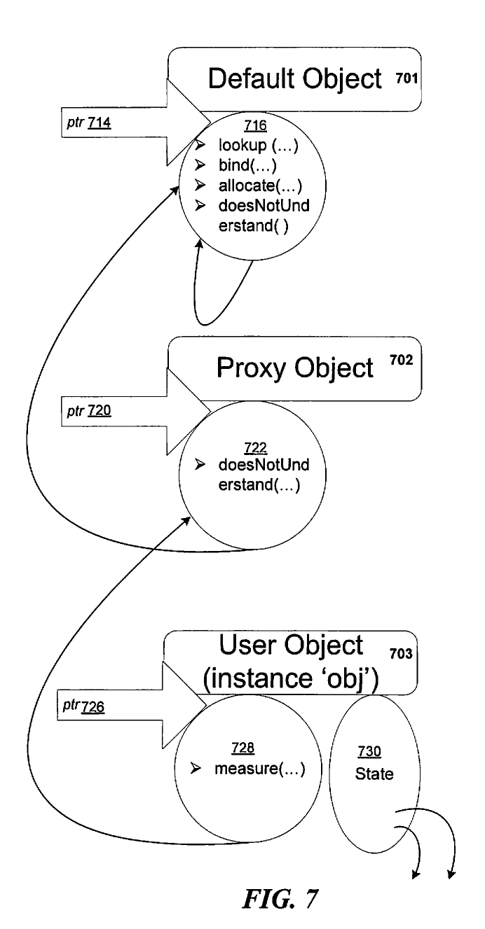

FIG. 7 depicts an example of proxy object delegation for remote access to unimplemented messages. By overloading the doesNotUnderstand( ), the proxy object 702 is utilized to do a remote lookup (all the way up to default object 701 if necessary), find and install the execution code, bind it for future usage at the ‘obj’ level and execute the code prior to returning. In some embodiments, the proxy object 702 can query another process at the host or for instance connect with a remote server. In addition, the program can be monitored to keep track what is executed often or not. Such analysis allows the end user to safely remove execution code and fine grain control over resources such as memory, because the user can ‘swap in or out code’ when necessary/needed, at all times. Identical mechanisms can perform runtime bug fixes (e.g., versioning), add functionality to a program without stopping, etc. Additionally, the proxy object can also send over the arguments and initiate a remote execution and receive the results (i.e. cloud computation) avoiding computation on the local, weaker, (target) host. For example, if the message measure was not yet implemented in user object 703, the proxy object 703 ‘catches’ the doesNotUnderstand ( ) message and executes a remote lookup, binding and execution.

Similar to objects discussed above, the default object 701 includes a pointer to itself 714 and defined methods 716. The proxy object 702 includes a pointer 720 and defined methods 722. The user object 703 includes a pointer 726, defined methods 728, and a state 730.

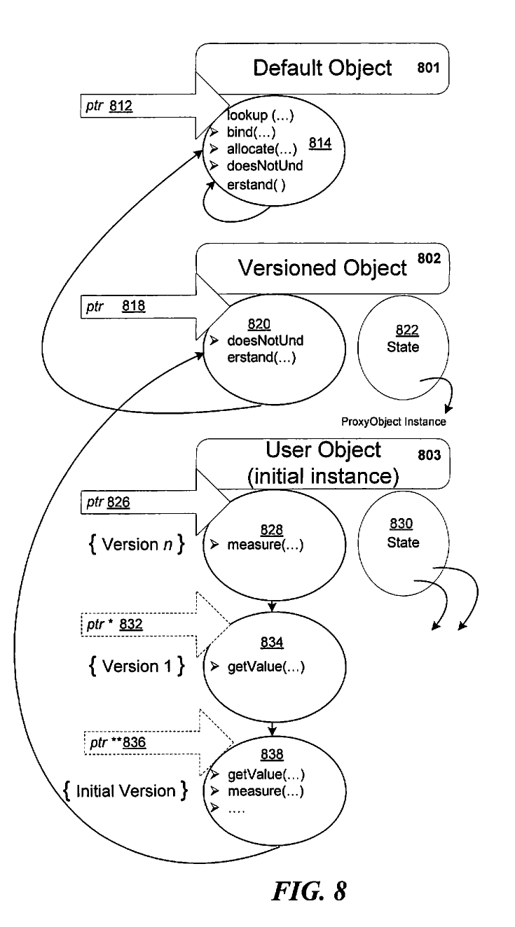

FIG. 8 depicts an example of the management of multiple versions of a user object. When a new version for one or more messages becomes available, the system inserts a new association of bindings with object code for these updated messages and also re-aligns the entrance reference. The acquisition of the new code is done through the proxy object (versioned object 802) as discussed above, which not only returns the code but also the version to where it belongs.

Versioned Object 802 installs (daisy-chains) a new lookup table in the user object 803, binds the installs the new version of the message, and adjusts the object entry point pointer. Here, the measure ( ) message in ‘version n’ overloads the earlier one and ‘DoesNotUnderstand ( )’ message is overloaded to handles the interaction with the versioned object 802. Such overloading of the doesNotUnderstand ( ) message allows again to add functionality or update at run time.

Removing a newer version is as simple as popping it of the stack and re-assigning the object entrance from ptr to ptr* or ptr**. In summary the object model allows to built a partial ‘skeleton’ for program execution and it can be filled in during runtime execution (swap in), parts of the program can also be safely removed while running (swap out) and better manage our memory resource. Fine grain control of the object versions, again at runtime, allow on the fly bug fixing and adding functionality.

Similar to objects discussed above, the default object 801 includes a pointer to itself 812 and defined methods 814. The versioned object 802 includes a pointer 818, defined methods 820, and a state 822. The user object 803 includes a pointer 836, defined methods 838, and a state 830. The user object 803 can further include subsequent versions with pointer 832 and defined methods 834, and pointer 826 and defined methods 828.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A system for runtime dynamic binding, comprising:
a processor for executing computer-readable instructions;
a computer-readable medium for storing an object definition in communications with the processor; and
a user object instantiated from the object definition, the object definition including a programmer-defined lookup method, a programmer-defined exception handling method, and a programmer-defined binding method, wherein
the programmer-defined lookup method dynamically searches and retrieves a requested functionality,
the programmer-defined exception handling method dynamically handling exceptions during run time, and
the programmer-defined binding method dynamically binds the requested functionality at runtime for execution without a system restart.

2. The system of claim 1, wherein the requested functionality is at least one of: computer-readable instructions for execution on the processor and computer-readable data.

3. The system of claim 2, wherein the requested functionality is retrieved from a remote server over a network.

4. The system of claim 2, wherein associated arguments are transmitted to a remote server and the requested functionality is executed at the remote server, and a result transmitted back to the user object over a network.

5. The system of claim 1, wherein the requested functionality is retrieved by the programmer-defined lookup method, in part, based on at least one of: hardware resources, software resources, and a requested functionality usage history.

6. The system of claim 1, wherein the user object is instantiated from at least one of: multiple versions of the object definition and multiple alternatives of the object definition.

7. The system of claim 1, wherein the user object further includes a current state and a programmer-defined method for interfacing with the current state.

8. The system of claim 1, wherein the requested functionality is locally defined and transmitted to a remote server over a network.

9. A method for providing runtime dynamic binding, comprising:
instantiating a user object from a object definition stored in a computer-readable memory, the object definition including a programmer-defined lookup method, a programmer-defined exception handling method, and a programmer-defined binding method, wherein
the programmer-defined lookup method dynamically searches and retrieves a requested functionality,
the programmer-defined exception handling method dynamically handling exceptions during run time, and
the programmer-defined binding method dynamically binds the requested functionality at runtime for execution without a system restart.

10. The method of claim 9, wherein the requested functionality is at least one of: computer-readable instructions for execution on the processor and computer-readable data.

11. The method of claim 10, wherein the requested functionality is retrieved from a remote server over a network.

12. The method of claim 10, wherein associated arguments are transmitted to a remote server and the requested functionality is executed at the remote server, and a result transmitted back to the user object over a network.

13. The method of claim 9, wherein the requested functionality is retrieved by the programmer-defined lookup method, in part, based on at least one of: hardware resources, software resources, and a requested functionality usage history.

14. The method of claim 9, wherein
the user object is instantiated from at least one of: multiple versions of the object definition and multiple alternatives of the object definition,
the user object further includes a current state and a programmer-defined method for interfacing with the current state, and
the requested functionality is locally defined and transmitted to a remote server over a network.

15. A computer-readable storage medium including instructions adapted to execute a method for providing runtime dynamic binding, the method comprising:
instantiating a user object from a object definition stored in a computer-readable memory, the object definition including a programmer-defined lookup method, a programmer-defined exception handling method, and a programmer-defined binding method, wherein
the programmer-defined lookup method dynamically searches and retrieves a requested functionality,
the programmer-defined exception handling method dynamically handling exceptions during run time, and
the programmer-defined binding method dynamically binds the requested functionality at runtime for execution without a system restart.

16. The medium of claim 15, wherein the requested functionality is at least one of: computer-readable instructions for execution on the processor and computer-readable data.

17. The medium of claim 16, wherein the requested functionality is retrieved from a remote server over a network.

18. The medium of claim 16, wherein associated arguments are transmitted to a remote server and the requested functionality is executed at the remote server, and a result transmitted back to the user object over a network.

19. The medium of claim 15, wherein the requested functionality is retrieved by the programmer-defined lookup method, in part, based on at least one of: hardware resources, software resources, and a requested functionality usage history.

20. The medium of claim 15, wherein
the user object is instantiated from at least one of: multiple versions of the object definition and multiple alternatives of the object definition,
the user object further includes a current state and a programmer-defined method for interfacing with the current state, and
the requested functionality is locally defined and transmitted to a remote server over a network.
